(19) United States
(12) Patent Application Publication
(10) Pub. No.: US 2005/0150083 A1
(43) Pub. Date: Jul. 14, 2005

(54) Utility handle providing enhanced grip and comfort

(76) Inventor: D. David Roberts, Scottsdale, AZ (US)

Correspondence Address: Rosenbaum & Associates, P.C.;Suite #380, 650 Dundee Road, Northbrook, IL, 60062, US

(21) Appl. No.: 10/754,021

(22) Filed: Jan. 8, 2004

(51) Int. Cl. E05B 1/00

(52) U.S. Cl. 16/430

(57) ABSTRACT

The present invention is directed to an improved handle, which is equipped on a hand tool, that provides a secure grip and reduces stress on a user's hand by providing a recessed surface area on a side of the handle for receiving a thumb, and a multi-ridged surface area on a side opposing the recessed surface area, the multi-ridged surface area providing at least two ridges that intercalate between an index finger and a middle finger and between a middle finger and a ring finger.

### BACKGROUND OF THE INVENTION

The present invention generally relates to the field of handles used with a variety of tools.

There are a variety of hand tools that aid a person in everyday life whether it is in the kitchen, in the garden, or in the garage. A hand tool typically enables the user to exert a certain force onto the hand tool though the gripping portion, or the handle, to facilitate the function of the hand tool. Often times the function of the hand tool, e.g., turning a screw or cutting a piece of meat, requires that the user repeat a movement with the hand tool. Repetitive use of a hand tool will cause physical strain on the hand of the individual and can often result in some type of injury to the user's hand. Also, repetitive use can increase the risk of slippage of the hand tool from the user's hand and run the risk of injury to the user or to another individual. As for users with chronic arthritis or other degenerative diseases that afflict the hand, often times the design of the handle makes gripping painful and use of the tool unbearable.

There are a number of handles in existence that aid in the grip of a hand tool either by contouring the handle one of a variety of ways, from the basic cylindrical shape to a curved back with opposing side having ridges that intercalate with the user's fingers. While the varied designs have their benefits, they each have their limitations by either failing to provide a secure grip or by failing to relieve stress, and sometimes pain, on the user's hand, or both.

One particular design for a handle for use on a poultry knife is disclosed in U.S. Pat. No. 6,460,256 (Peppel, Alan S., et al.). The handle is disclosed as an ergonomic handle that consists of a lower surface with an index finger engaging surface and an opposing upper surface with a thumb engaging surface. Alternate embodiments are described (see FIGS. 11A-C) that provide concave thumb engaging surfaces either on one side or the other. While this handle attempts to provide improvements over existing designs, problems still remain. In particular, the underside of the handle only provides a distal abutment for the index finger and fails to secure the remaining fingers. Also, all embodiments engage the fingers on the bottom side, which creates spatial problems as the fingers prevent additional downward movement of the knife because the fingers will inherently come in between the knife and any cutting surface.

Another design utilizes a moldable material to form the surface of the handle, as shown in U.S. Pat. No. 5,155,878 (Dellis). In this example the handle needs to be heated and then the handle can be molded to conform to the user's hand grip. While this handle allows for custom-shaped handles that conform to the user's grip, a cumbersome heating process is required. This heating process must be repeated if a different user is using the handle. Also, the heating process could result in risk of burning to the user.

There still remains a need for a handle that provides a user a secure grip and relieves stress on the user's hand, especially during extensive use of the hand tool on which the handle is located.

### SUMMARY OF THE INVENTION

The present invention addresses the above-mentioned needs in the art and, more specifically, includes a handle to be used on hand tools that provides a more secure grip for a user while relieving stress on the user's hand.

In general, the present invention comprises a contoured handle that includes a plurality of recessed surface areas that can receive at least a finger and a thumb. The plurality of recessed surface areas are situated on the handle so that the recessed surface areas for receiving a finger are located on one side of the handle, while the recessed surface area for receiving a thumb is locate on the opposite side. The recessed surface areas for receiving a finger are separated from one another by a protruding ridge, which assists in securing the position or grip of a user's fingers. This arrangement allows for the hand of a user to grip the handle in a comfortable manner and provide the user a secure grip that allows for exertion of force with minimal risk of slippage.

One aspect of the present invention includes a slightly curved handle that accommodates the slight curvature of the palm of a user's hand.

These aspects and additional aspects of the present invention will be understood by one of ordinary skill upon reviewing the provided disclosure along with the drawings.

### BRIEF DESCRIPTION OF THE DRAWINGS

FIG. 1 is a side perspective view of an embodiment of the invention.

FIG. 2 is another side perspective view of an embodiment of the invention.

FIG. 3 is a top planar view of an embodiment of the invention.

FIG. 4 is a bottom planar view of an embodiment of the invention.

### DETAILED DESCRIPTION OF THE PREFERRED EMBODIMENTS

The present invention relates to an improved handle that provides a user a secure grip with reduced stress on the user's hand. The improved handle is useful with an assortment of hand-operated tools whether the tools are for the kitchen, garden or general handy work. Hand-operated tools include the following non-limiting examples: a spatula, mixer, ice cream scoop, spade, scraper, culinary knife, pizza cutter, and paint brush.

The improved handle provides specific recessed surface areas for positioning a user's thumb and at least one of the user's fingers for securely gripping the improved handle. In general, these specific areas result in the user's thumb being essentially opposed on the opposite side of the improved handle by at least one of the user's fingers. This opposed arrangement provides for a firm grip as the user's thumb and at least one finger firmly squeeze the improved handle against one another. The recessed surface area for receiving a thumb is shaped to receive a thumb as the thumb is aligned parallel to the long axis of the improved handle. Whereas, the recessed surface area for receiving fingers are shaped to receive fingers as they are positioned nearly perpendicular to the long axis of the improved handle and the length of the thumb, when the thumb is engaged on the improved handle. This alignment of thumb and fingers allows for a comfortable grip as the thumb is perpendicular to the fingers as when a fist is formed with the thumb pointing upward, as typically seen in a “thumbs up” signal using one's hand.

The improved handle also provides at least one protruding ridge that separates adjacent recessed surface areas for receiving fingers and allows the user to grip the improved handle more securely as the ridge provides an abutment that prevents slippage of gripping fingers. The protruding ridge also adds comfort to the grip. In particular, when significantly raised, the protruding ridge wedges between at least a pair of adjacent fingers preventing fingers from bunching together and rubbing against one another during ongoing use of a hand tool equipped with the improved handle.

The improved handle is generally cylindrical in shape, allowing a user to grip the improved handle in a natural manner such as when making a fist. Preferably, the radius of the cylindrical shape is large enough to allow for a comfortable and secure grip without being too large so that gripping the improved handle would be cumbersome. The improved handle has a slightly curved shape along the length of the handle so that the curved shape compliments the curved nature of a user's palm. A top side view of the improved handle shows the convex nature of the curved shape. This complimentary curvature allows for the improved handle to comfortably fit within the palm of a user. Also, the curvature provides additional support towards keeping the fingers from slipping along the length of the improved handle as the user squeezes user's grip around the improved handle.

Furthermore, the contour of the improved handle relieves stress from the user's hand, especially as the user undergoes prolonged use of the hand tool equipped with the improved handle. Again, the curved shape of the improved handle provides comfort as the hand is allowed to adopt its naturally curvature. Also, the recessed surface areas for the thumb and fingers allows the user to squeeze the improved handle optimally as the thumb opposes the fingers on opposite sides of the improved handle, thereby requiring less force to securely grip the improved handle. The positioning of thumb and fingers along the sides of the improved handle also allows the user to move the improved handle up and down in a chopping motion, e.g., when wielding a knife, with the user's palm facing down. This movement is more natural and creates less stress on the wrist. This positioning of the user's hand also allows for a user to force the improved handle, and the hand tool to which it is attached, against a flat surface area without smashing the user's fingers. This aspect provides much comfort to the user during operations that include chopping or cutting objects on a flat surface, e.g., cutting food items on a cutting board.

In certain hand tools, the improved handle will require side to side motion or tilting in order to operate the hand tool. In such hand tools, the improved handle still provides the secure grip as discussed above, but the improved handle also enables the user to effectively apply force to either side of the improved handle as both the thumb and at least one of the fingers are positioned on the sides of the improved handle. In this position, the thumb and the at least one finger can easily apply force to opposing sides of the improved handle to cause the hand tool, to which the improved handle is attached, to move and function as intended.

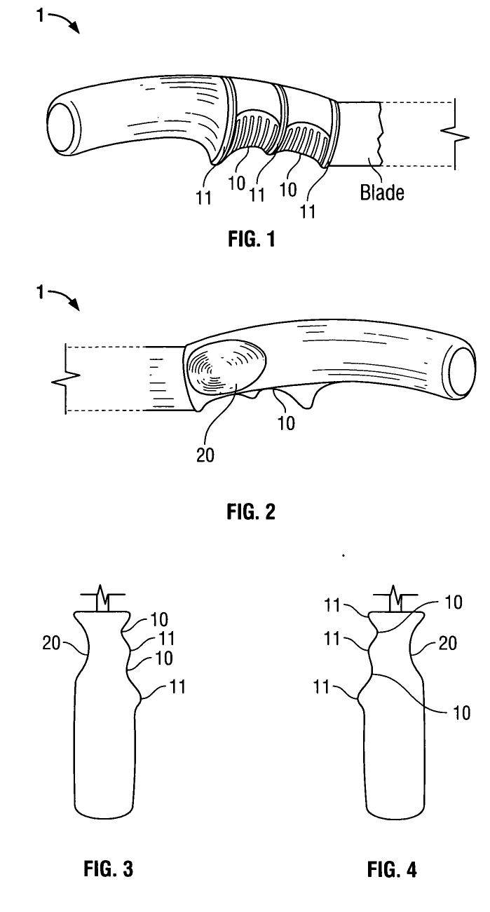

An embodiment of the present invention is illustrated in FIGS. 1-4. FIGS. 1-2 are opposite side views of a handle 1 having a generally cylindrical shape with a slightly curved length. FIG. 1 also shows a pair of recessed surface areas for receiving a finger 10, which are separated and defined by a series of protruding ridges 11. On the opposite side from the surfaces areas for receiving a finger 10 is a recessed surface area for receiving a thumb 20. Both the recessed surface areas are situated towards the distal end of the improved handle 1, which is the end that has the functional element of the hand tool attached to it, such as the knife depicted in the figures. The recessed surface area for receiving a thumb 20 is situated at nearly the same position as the recessed surface area for receiving a finger 10 along the length of the improved handle 1. This allows a user to ideally grip the improved handle 1, as the force of the thumb will be directly opposed by the force of the finger as they squeeze the improved handle.

FIG. 3 shows a top view of a horizontal cross section along the length of the handle, while FIG. 4 shows the bottom view. Both figures show the side contours that include the recessed surface areas for receiving a finger 10 along with the series of protruding ridges 11 on one side and a recessed surface area for receiving a thumb 20.

1-6. (canceled)

7. An ergonomic handle grip for a hand-held implement, comprising:
a generally elliptically-shaped main handle body member having a longitudinal axis and a circumferential axis, upper and lower aspects of the main handle body member being positioned along semi-major axes and opposing lateral side surfaces being positioned along semi-minor axes of the generally elliptical-shaped main handle body member, a forward end and a rearward end, the main handle body member being curved along its longitudinal axis from the forward end and the rearward end, and having a plurality of recessed regions and raised regions for accommodating a user's hand and finger grip thereupon, a thumb recess on one of the opposing lateral side surfaces and proximate the forward end of the main handle body member; at least two recesses on a second of the opposing lateral side surfaces which extend circumferentially from the second of the opposing lateral side surfaces to a lower surface of the main handle body member and proximate the forward end of the main handle body member, and a first projection distal the at least two recesses.

8. The ergonomic handle grip according to claim 7, further comprising a second projection extending circumferentially about a portion of the main handle body member and positioned intermediate a pair of the at least two recesses on the second of the opposing lateral side surfaces.

9. The ergonomic handle grip according to claim 8, further comprising a third projection extending circumferentially about a portion of the main handle body member and positioned intermediate a second pair of the at least two recesses on the second of the opposing lateral side surfaces.

10. The ergonomic handle grip according to claim 7, wherein the curve of the main handle body member approximates an anatomical curve of a human palm when the main handle body member is gripped.

11. The ergonomic handle grip according to claim 7, wherein the thumb recess has a generally elliptical shape with the semi-major axis of the thumb recess being generally parallel to the longitudinal axis of the main handle body member.

12. The ergonomic handle grip according to claim 11, wherein the generally elliptical shaped thumb recess is adapted to position a user's thumb generally parallel to the longitudinal axis of the main handle body member.

13. The ergonomic handle grip according to claim 11, wherein the at least two recesses each flintier comprise a generally U-shaped recess in the main handle body member, with raised projection extending generally circumferentially along at least a portion of the main handle body member and intermediate the at least to generally U-shaped recesses.

14. The ergonomic handle grip according to claim 13, wherein a fist of the at least two generally U-shaped recesses being most proximate the forward end of the main handle body member is adapted to accommodate a user's index finger therein.

15. The ergonomic handle grip according to claim 14, wherein a second of the at least two generally U-shaped recesses being adjacent to the first of the at least two generally U-shaped recesses is adapted to accommodate a user's middle finger therein.

16. The ergonomic handle grip according to claim 15, wherein the first projection is longitudinally adjacent the second of the at least two generally U-shaped recesses.

17. The ergonomic handle grip according to claim 16, wherein the first projection has a height sufficient to separate a user's middle finger from the user's ring finger when the user grips the main handle body member.

18. The ergonomic handle grip according to claim 7, further comprising a knife blade joined to a forward end of the main handle body member.

19. An ergonomic hand-held knife, comprising:
a generally elliptically-shaped handle member having a longitudinal axis and a circumferential axis, upper and lower aspects of the handle member being positioned along semi-major axes and opposing lateral side surfaces being positioned along semi-minor axes of the generally elliptical-shaped handle member, a distal end and a proximate end, the handle member being curved along its longitudinal axis from the forward end and the rearward end, and having a plurality of recessed regions and raised regions for accommodating a user's hand and finger grip thereupon, a generally elliptical shaped recess in a first of the opposing lateral surfaces proximate the forward end of the handle member, the generally elliptical shaped recess having its semi-major access generally parallel to the longitudinal axis of the handle member; at least one generally U-shaped recess extending at least partially circumferentially about a second opposing lateral surface of the handle member, the generally elliptical shaped recess and the at least one generally U-shaped recess being positioned proximate the distal end of the handle member such that a user's thumb is engaged in the generally elliptical shaped recess and a user's forefinger is engaged in the at least one generally U-shaped recess in a gripping manner which exerts opposing gripping forces against the handle member, and
a knife blade extending from the distal end of the handle member such that a sharp edge of the knife is positioned generally in-line with the lower aspect of the handle member and an upper edge of the knife is positioned generally in-line with the upper aspect of the handle member.

20. The ergonomic handle grip according to claim 19, further comprising a first projection extending at least partially circumferentially about a lateral surface of the handle member and positioned proximate the at least one generally U-shaped recess thereby forming a finger abutment.

21. The ergonomic handle grip according to claim 20, further comprising at least two generally U-shaped recesses and a second projection extending
